(19) United States
(12) Patent Application Publication
(10) Pub. No.: US 2007/0058796 A1
(43) Pub. Date: Mar. 15, 2007

(54) COMPUTER-AIDED PROCESSING OF A VOTING MESSAGE AND DETERMINATION OF A VOTING RESULT

(75) Inventors: Andreas Schmidt, Braunschweig (DE); Norbert Schwagmann, Braunschweig (DE); Holger Schmidt, Braunschweig (DE)

Correspondence Address: DICKSTEIN SHAPIRO LLP, 1177 AVENUE OF THE AMERICAS 6TH AVENUE, NEW YORK, NY, 10036-2714, US

(73) Assignee: INFINEON TECHNOLOGIES AG, Munich (DE)

(21) Appl. No.: 11/466,205

(22) Filed: Aug. 22, 2006

(30) Foreign Application Priority Data
Aug. 22, 2005 (DE) 10 2005 039 669.0

(51) Int. Cl. H04M 3/42

(52) U.S. Cl. 379/202.01

(57) ABSTRACT

A voting message which includes a voting question is coded in accordance with a transport-protocol control protocol, for example in accordance with the real-time transport control protocol, and is sent in the course of a conference, in order to initiate a voting.

### CROSS-REFERENCE TO RELATED APPLICATION

This application claims priority to German Patent Application Serial No. 10 2005 039 669.0-31, which was filed on Aug. 22, 2005, and is incorporated herein by reference in its entirety.

### TECHNICAL FIELD

The invention relates to a method for computer-aided creation of a voting message, to a method for determination of at least one voting result of at least one voting, a method for computer-aided processing of a voting message, transport control protocol units, a conference voting evaluation unit, a conference server unit and a communication terminal.

### BACKGROUND OF THE INVENTION

In a modem communication system, it is frequently desirable to provide a conference between a plurality of subscribers, in other words between a plurality of communication terminals, within the communication system. A communication system which provides a conference system such as this makes it possible to use communication terminals to communicate between a plurality of users. Conference systems which allow participants of a conference to perform a voting are desirable.

### SHORT DESCRIPTION OF THE FIGURES

FIG. 1 shows an architecture of a push-to-talk-communication system according to one exemplary embodiment of the invention; and

FIG. 2 shows a message flowchart, illustrating the message flow in the course of a voting process according to one exemplary embodiment of the invention.

### DETAILED DESCRIPTION

In the following text, by way of example, a conference system is understood as being an Internet-Protocol-based conference system or a so-called push-to-talk system, or in general any system in which it is possible for communication terminals within a communication system to communicate with one another within a communication conference, that is to say to allow data to be transmitted between the communication terminals.

A push-to-talk-communication system (PTT communication system) is understood as meaning, for example, the “Direct Connect” communication system from the Nextel Company in the USA or the Push-to-talk over Cellular (PoC) communication system from the Open Mobile Alliance (OMA), with a PTT communication system being a multiple subscriber communication system for mobile radio communication terminals, for example for mobile radio telephones. A speaker normally operates a specific button on his mobile radio communication terminal, in an analogous manner to the handling of walky-talkies, in order to question speech rights and then to transmit speech messages to other mobile radio communication terminals within the PPT communication session. The transmission of messages from other users of other mobile radio communication terminals is inhibited during this time. The PTT communication system is thus normally a half-duplex communication system.

According to one proposal from the IETF (Internet Engineering Task Force) or else in a modem push-to-talk communication system, the media data to be transmitted in a conference system, for example audio data and/or video data and/or still-image data and/or text data, is transmitted by means of the so-called Real-Time Transport Protocol (RTP). The media data streams are monitored by means of the so-called Real-Time Transport Control Protocol (RTCP).

Both a conference system and a push-to-talk communication system have a centralized architecture. In other words, this means that the subscribers to a conference system such as this do not communicate directly with one another, but that the communication takes place by means of a central server unit. The central server unit, which is also referred to as the conference server unit, is arranged in a mobile radio communication system in the non-mobile area of the communication network, for example in the core network in the case of UMTS (Universal Mobile Telecommunications System).

In a push-to-talk communication system, the request button on the subscriber communication terminals can be used for a simple (two-value) voting.

According to one embodiment of the invention, a computer-aided voting may be carried out in a simple manner in a conference system.

In one embodiment of the invention, a method for computer-aided creation of a voting message in a conference between a plurality of communication terminals is provided, wherein the voting message is coded in accordance with a transport-protocol control protocol, for example a real-time transport-protocol control protocol, by means of which a transport protocol, for example a real-time transport protocol, is controlled, with an information item which identifies at least one voting question or at least one voting response being added to the voting message.

In one embodiment of the invention, a method for determination of at least one voting result of at least one voting in a conference between a plurality of communication terminals is provided, wherein at least one received voting response message, which is coded in accordance with a transport-protocol control protocol, for example a real-time transport-protocol control protocol, by means of which a transport protocol, for example a real-time transport protocol, is controlled, is decoded, with the voting response message including at least one response to the at least one voting question for voting. The at least one response is determined from the decoded voting response message, and the at least one voting result is determined using the at least one determined response.

In one embodiment of the invention, a method for processing a voting message in a conference between a plurality of communication terminals is provided, wherein a voting message is received which is coded in accordance with a transport-protocol control protocol, for example in accordance with a real-time transport-protocol control protocol, by means of which a transport protocol, for example a real-time transport protocol, is controlled, and an information item which identifies at least one voting question and/or an information item which identifies at least one voting response and are/is contained in the voting message are/is determined from the voting message. The at least one voting question and/or at least one voting response are/is displayed to a user of a communication terminal which is taking part in the voting, and a user enters at least one response to the at least one voting question, in other words it carries out a voting process in accordance with the voting question. Furthermore, a voting response message is coded in accordance with a transport-protocol control protocol, for example a real-time transport protocol control protocol, by means of which a transport protocol, for example a real-time transport protocol, is controlled, with an information item which identifies the at least one response to the at least one voting question being added to the voting response message.

According to another embodiment of the invention, a transport-protocol control protocol unit is provided, for example a real-time transport protocol control protocol unit, creating a voting message in a conference between a plurality of communication terminals, with the voting message being coded in accordance with a transport-protocol control protocol, for example a real-time transport-protocol control protocol, by means of which a transport protocol, for example a real-time transport protocol, is controlled, and with an information item which identifies at least one voting question and/or an information item which identifies at least one voting response being added to the voting message.

According to another embodiment of the invention, a conference voting evaluation unit is provided having a transport-protocol control protocol unit, for example a real-time transport-protocol control protocol unit, decoding at least one voting response message which is coded in accordance with a transport-protocol control protocol, for example a real-time transport-protocol control protocol, by means of which a transport protocol, for example a real-time transport protocol, is controlled. Furthermore, a determination unit is provided determining at least one response to at least one information item, which identifies a voting question, from the decoded voting response message, as well as a voting evaluation unit, determining a voting result using the at least one information item which identifies the response to at least one voting question.

A conference server unit has a conference voting evaluation unit as described above.

Furthermore, a transport-protocol control protocol unit is provided, for example a real-time transport protocol control protocol unit, creating a voting response message in a conference between a plurality of communication terminals, with the voting response message being coded in accordance with a transport-protocol control protocol, for example a real-time transport-protocol control protocol, by means of which a transport protocol, for example a real-time transport protocol, is controlled, with an information item which identifies at least one voting response to at least one voting question being added to the voting response message.

A communication terminal has a conference unit taking part in, or in other words providing, a conference with at least one other communication terminal. Furthermore, a first transport-protocol control protocol unit is provided, for example a real-time transport-protocol control protocol unit, decoding at least one voting message which is coded in accordance with a transport control protocol, for example a real-time transport-protocol control protocol, by means of which a transport protocol, for example a real-time transport protocol, is controlled. Furthermore, the communication terminal has a determination unit for determination of at least one information item, which identifies a voting question and/or at least one voting response, from the decoded voting message, as well as a display unit for displaying the determined information or the at least one voting question and/or at least one voting response determined from this to a user. An input unit is provided in order to input at least one response to the at least one voting question. Furthermore, a second transport-protocol control protocol unit is provided, for example a second real-time transport-protocol control protocol unit, creating a voting response message in a conference between a plurality of communication terminals, with the voting response message being coded in accordance with a transport-protocol control protocol, for example a real-time transport-protocol control protocol, by means of which a transport protocol, for example a real-time transport protocol, is controlled, with an information item which identifies the at least one response to the at least one voting question being added to the voting response message.

According to one embodiment of the invention a voting capability is provided as a communication service within a communication conference between a plurality of communication terminals in a communication system, with the information which is relevant for voting purposes, for example the voting question and/or possible voting response or responses which is or are predetermined or else is or are freely defined by a user of a participating communication appliance, being transmitted using a transport-protocol control protocol, for example a real-time transport-protocol control protocol.

This makes it possible to use a transport-protocol control protocol rather than a proprietary protocol resulting in considerable improvements in terms of the performance of the overall data interchange.

In other words, according to one embodiment of the invention, a voting message or voting messages is or are sent as messages in accordance with the transport-protocol control protocol, for example, the real-time transport-protocol control protocol, in a communication system which uses a transport-protocol control protocol, for example a real-time transport-protocol control protocol.

One voting message may contain one or more voting questions or one or more voting responses which a user who is taking part in the voting process can select.

The voting response message may contain one or more responses to the voting question, for example a response which can be freely formulated by the user, or alternatively selection information about a selected response, which is predetermined for the user for selection.

The information which identifies the voting question or the voting response may be a cross-reference to a voting response or voting question stored in another server unit, in which case, for example, unambiguous addressing is provided to the question or the response by using, for example, a Unique Resource Identifier (URI) which may be information or else may be the voting question or the voting response itself, which may be included in the respective voting message or in the voting response message.

The real-time transport control protocol (RTCP) may be used as the real-time transport-protocol control protocol.

The real-time transport protocol (RTP) may be used as the real-time transport protocol.

The voting can be carried out in the course of a half-duplex conference, for example in the course of a push-to-talk conference, for example a “direct connect” conference or a Push-to-talk over Cellular conference (PoC conference).

Alternatively, the voting may be carried out in the course of an Internet-Protocol-based conference or using the Internet conferencing framework.

The at least one voting response message may be received in the course of the method for computer-aided determination of at least one voting result by a conference server unit, and/or the at least one voting result may be determined by a conference server unit.

In another embodiment of the method for computer-aided determination of at least one voting result, provision is made for the determined at least one voting result to be transmitted to at least one communication terminal which is taking part in the conference, for example to the communication terminal which initiated the at least one voting. This embodiment of the invention can be regarded as being for the conference server unit or else some other unit which determines the voting result to pass on this result to one or more other communication terminals, in which case it is possible to provide for only that communication terminal which initiated the at least one voting to have the right to receive the voting result. However, alternatively, it is possible to provide for all of the communication terminals which are involved in the voting to have the voting result transmitted to them. The respective rights can be predetermined by the communication terminal initiating the voting, or alternatively the conference server unit or the unit determining the voting result can predetermine these rights.

According to another embodiment of the method for computer-aided determination of at least one voting result, the at least one voting response message is received by a conference server unit, and the voting response message and/or a voting response information item which contains at least one voting response message is transmitted to at least one communication terminal which is taking part in the conference, for example to the communication terminal which initiated the voting.

According to one embodiment of the method for processing a voting message, provision is made for the voting response message to be sent to a conference server unit.

The real-time transport-protocol control protocol units may be designed in accordance with the real-time transport control protocol (RTCP).

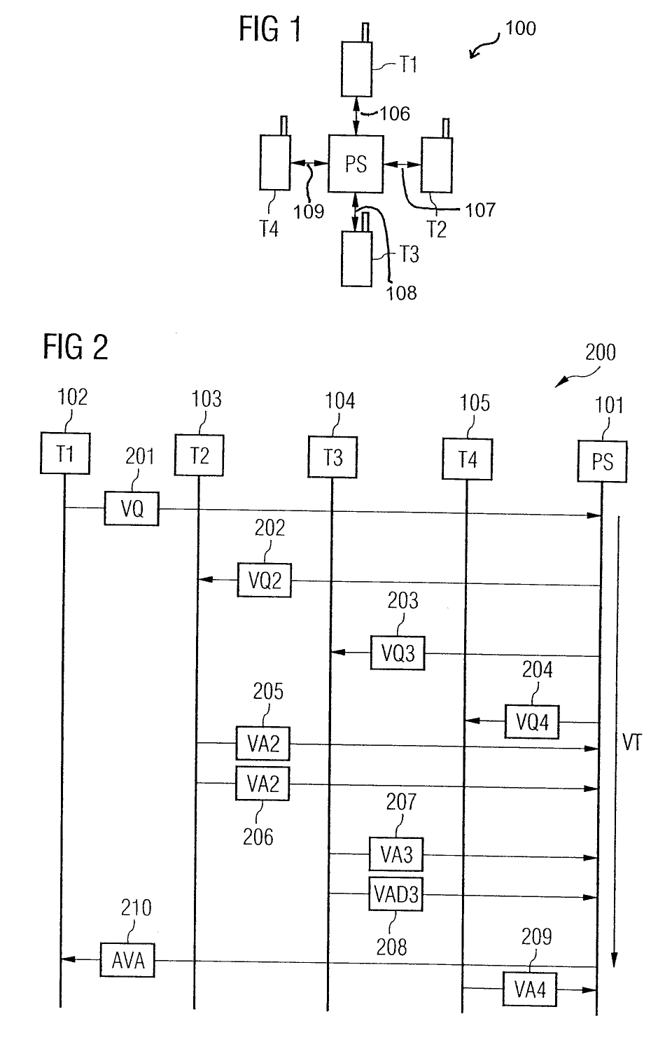

A push-to-talk over cellular communication system (PoC communication system) 100 will be described in the following text as an exemplary embodiment (see FIG. 1), in which case it should be noted that, in an alternative embodiment, a different push-to-talk communication system or else a different communication system, for example a different half-duplex communication system, may be used as well, or the communication conference system in accordance with the IETF conferencing framework.

The following text is based on the assumption that, in a push-to-talk conference which is produced by a central push-to-talk server unit 101, four mobile radio communication terminals 102, 103, 104, 105, which each include a push-to-talk over cellular client have set up a push-to-talk conference with one another.

The expression a half-duplex conference means a conference in which at most one participating communication terminal rather than a plurality of communication terminals has the right to speak at any one time. Only one communication terminal thus has, for example, the right to speak at any given time, or expressed in general terms the right to introduce data into the communication conference and to transmit data to the other communication terminals taking part. The other communication terminals can only receive the data that is introduced and, without their own right to speak or their own communication right, cannot introduce any data, and in particular also cannot introduce any voice messages, into the communication conference, for example a telecommunication conference.

Four mobile radio communication terminals 102, 103, 104, 105 are taking part in the conference provided by the push-to-talk over cellular conference server unit 101, specifically a first mobile radio communication appliance 102, a second mobile radio communication appliance 103, a third mobile radio communication appliance 104 and a fourth mobile radio communication appliance 105. Each mobile radio communication terminal 102, 103, 104, 105 is connected by means of a respective bidirectional mobile radio communication link 106, 107, 108, 109 to the conference server unit 101, and can thus receive data in the course of the conference from the other mobile radio communication terminals and/or, when the respective mobile radio communication terminal has been assigned the communication right, it can send data to the other mobile radio communication terminals.

According to this exemplary embodiment of the invention, voice messages, or in other words audio messages, are transmitted between the mobile radio communication terminals 102, 103, 104, 105, in which case it should be noted that other media data can also be transmitted in an alternative conference, for example video data and/or still-image data and/or text data.

The audio data is transmitted between the mobile radio communication terminals 102, 103, 104, 105 using the so-called real-time transport protocol (RTP) as the real-time transport protocol. The data streams, that is to say according to this exemplary embodiment of the invention, the audio data, are monitored using the real-time transport control protocol (RTCP) as the real-time transport-protocol control protocol.

According to this exemplary embodiment of the invention, a first subscriber T1, that is to say the user of the first mobile radio communication terminal 102, initiates a voting between the subscribers in the push-to-talk communication session, obviously a push-to-talk conference, by sending a voting question (see the message flowchart 200 in FIG. 2). The voting question is inserted into a voting message 201, which is produced by the first subscriber T1 using the first mobile radio communication terminal 102.

The voting message 201 has the message format illustrated in Table 1 below, and is coded in accordance with RTCP. The voting message 201 contains a voting question as text, and details about possible voting responses. Furthermore, the voting message 201 is used to state the time period in which responses to the voting question will be accepted in the course of the voting process that has been started.

TABLE 1
format of the RTCP message for initiation of voting

0 1 2 3
0 1 2 3 4 5 6 7 8 9 0 1 2 3 4 5 6 7 8 9 0 1 2 3 4 5 6 7 8 9 0 1
+-+-+-+-+-+-+-+-+-+-+-+-+-+-+-+-+-+-+-+-+-+-+-+-+-+-+-+-+-+-+-+-+
|V=2|P|1 0 1 0 0| PT=APP=204 | length |
+-+-+-+-+-+-+-+-+-+-+-+-+-+-+-+-+-+-+-+-+-+-+-+-+-+-+-+-+-+-+-+-+
| SSRC of voting initiator |
+-+-+-+-+-+-+-+-+-+-+-+-+-+-+-+-+-+-+-+-+-+-+-+-+-+-+-+-+-+-+-+-+
| name=PoC1 |
+-+-+-+-+-+-+-+-+-+-+-+-+-+-+-+-+-+-+-+-+-+-+-+-+-+-+-+-+-+-+-+-+
| SDES CNAME item followed by SDES NAME item |
+-+-+-+-+-+-+-+-+-+-+-+-+-+-+-+-+-+-+-+-+-+-+-+-+-+-+-+-+-+-+-+-+
| voting question length | voting question text= |
| What is the name of the highest mountain in the world?; |
| 123456789; 123458470; |
|Selection type; 1;Mont Blanc; Mount Everest; Brocken | padding
+-+-+-+-+-+-+-+-+-+-+-+-+-+-+-+-+-+-+-+-+-+-+-+-+-+-+-+-+-+-+-+-+

In detail, the meanings of the fields in the RTCP message illustrated in Table 1 are as follows:
V=2:
RTP version number;
P:
indicator for padding;
10100:
Sub-type of message 10100 means “Voting_Question”. The stated value is only an exemplary value and may also be chosen differently;
PT=APP=204:
Indicator for an application-defined RTCP message;
Length:
Length of the message after length field in words (32 bits);
SSRC
Synchronization Source of the initiating PoC subscriber. The SSCR unambiguously identifies the sender of media streams, and is defined in the RTP packets associated with the RTCP message;
Name=PoC1
Application-defined message name (PoC1=PTT over Cellular Version 1);
SDES CNAME item followed by SDES NAME item:
CNAME and NAME of the subscriber terminal which initiates the voting. CNAME and NAME are so-called SDES items which are defined in SDES RTCP packets, in order to describe an RTP subscriber;
CNAME is a unique name of the subscriber, which also still exists outside specific RTP sessions (for example comprising a user name and host IP address);
NAME is any desired name of the subscriber, which is typically specified by the subscriber himself;
NAME need not uniquely identify the subscriber; as in the case of SDES RTCP packets, the list of SDES items CNAME and NAME is uniquely terminated by an SDES item of the 00000000 type; the list is then padded with zeros up to multiples of 32 bits;
Voting question length:
Length of the “voting question text” field in bytes; the “voting question length” field comprises 16 bits;
Voting question text:
Text for the specification of the voting initiation;
Padding:
Zeros for filling the “voting question length and text” field to integer multiples of 32 bits.

The “Voting question text” field of the voting message 201 has the following content, by way of example:

What is the name of the highest mountain in the world?; 123456789;123458470;

Selection type; 1; Mont Blanc; Mount Everest; Brocken

The contents mean:
Voting question=What is the name of the highest mountain in the world?
Voting time period=from 123456789 to 123458470 (the time details are absolute time details in the network time protocol (NTP) time stamp format, in which case it should be noted that relative time details, for example relative time details starting from the time of transmission of the voting message or the creation of the voting message 201 in an alternative embodiment may also be used;
Type of responses to the question=selection type (that is to say one of a number of possible responses should be selected);
Number of responses to be selected=1
Possible responses=Mount Blanc; Mount Everest; Brocken.

The voting message 201 is coded by means of an RTCP unit, which is provided in each of the mobile radio communication terminals 102, 103, 104, 105, in accordance with the RTCP format by the first mobile radio communication terminal 102.

Furthermore, each mobile radio communication terminal 102, 103, 104, 105 has a second RTCP unit for decoding a received message which has been coded in accordance with the RTCP format. The two units may be provided integrated in one RTCP unit.

The voting message 201 is transmitted to the conference server unit 101 which, on reception of the voting message 201, produces further voting messages VQ2, VQ3, VQ4, once again in accordance with the RTCP format by means of an RTCP unit which is provided in the conference server unit 101, and transmits them to the other mobile radio communication terminals 103, 104, 105 which are taking part in the conference.

As is illustrated in FIG. 2, the conference server unit 101 thus produces a second voting message 202 and sends this to the second mobile radio communication terminal 103, and thus to the second subscriber T2. Furthermore, the conference server unit 101 produces a third voting message 203 and transmits this to the third communication terminal 104, that is to say to the third subscriber, T3. Furthermore, the conference server unit 101 produces a fourth voting message 204, and transmits this to the fourth mobile radio communication terminal 105, that is to say to the fourth subscriber T4.

The voting messages 202, 203 and 204 which are produced are identical to the received voting message 201, according to this exemplary embodiment of the invention.

After reception of the respective voting message 202, 203, or 204, the RTCP units decode the respectively received voting message 202, 203, 204 and in each case use the decoded voting message to determine the voting question and present this by means of a presentation unit, for example by means of a screen (for visual information) or by means of a loudspeaker (for audio information) to the respective subscriber T2, T3, T4.

In the simplest case, the voting question is indicated in the form of a question text to the subscribers T2, T3, T4 on the respective screen of the respective mobile radio communication terminal 103, 104, 105. The subscribers T2, T3, T4 are also presented with the possible voting responses, which are likewise included in the voting messages 202, 203, 204 and are determined by the RTCP units in the mobile radio communication terminals 103, 104, 105. According to this exemplary embodiment of the invention, the three possible responses (that is to say “Mont Blanc”, “Mount Everest”, “Broken”) are displayed in text with the capability to select one of the texts using so-called “radio buttons”, that is to say by means of a selection element in which one and only one element can in each case be selected from a plurality of possible elements to be selected. Alternative embodiments also provide for the selection of a plurality of possible responses, in this case using other selection elements, which are presented to the respective subscriber T2, T3, T4 on his respective screen of his respective mobile radio communication terminal 103, 104, 105. Each mobile radio communication terminal 103, 104, 105 uses the respective voting message 202, 203, 204 to determine the time in which a response can still be selected, and thus whether it is still possible to select any response at all. If a response can still be selected, that is to say the response time has not yet elapsed, then the mobile radio communication terminals 103, 104, 105 optionally indicate this to the respective subscriber T2, T3, T4 on the screen, for example by means of a suitable icon, by emphasis of a specific display area or else by emphasis of a specific part of the text that is displayed to the respective subscriber T2, T3, T4. For example, it is possible for a mobile radio communication terminal 103, 104, 105 to indicate to the subscriber T2, T3, T4 by means of a blinking text in the presentation that this text can (still) be responded to. During the response phase, that is to say for as long as the response time lasts, as is illustrated by way of example in the above voting message in Table 1, it is optionally possible to continuously display the time that is still remaining to the subscriber T2, T3, T4 for selection of the response.

This exemplary embodiment is based on the assumption that the second subscriber T2 selects the second of the possible responses by means of an appropriate input to the second mobile radio communication terminal 103. The second mobile radio communication terminal 103 then produces a first voting response message 205 in accordance with the RTCP format, and sends this to the conference server unit 101.

Table 2, below, illustrates one example of a format for the first voting response message 205:

TABLE 2
format of the RTCP message in order to respond to a voting question

0 1 2 3
0 1 2 3 4 5 6 7 8 9 0 1 2 3 4 5 6 7 8 9 0 1 2 3 4 5 6 7 8 9 0 1
+-+-+-+-+-+-+-+-+-+-+-+-+-+-+-+-+-+-+-+-+-+-+-+-+-+-+-+-+-+-+-+-+
|V=|2|P 1 0 1 0 1| PT=APP=204 | length |
| SSRC of responding participant |
+-+-+-+-+-+-+-+-+-+-+-+-+-+-+-+-+-+-+-+-+-+-+-+-+-+-+-+-+-+-+-+-+
| name=PoC1 |
+-+-+-+-+-+-+-+-+-+-+-+-+-+-+-+-+-+-+-+-+-+-+-+-+-+-+-+-+-+-+-+-+
| SDES CNAME item followed by SDES NAME item |
+-+-+-+-+-+-+-+-+-+-+-+-+-+-+-+-+-+-+-+-+-+-+-+-+-+-+-+-+-+-+-+-+
| voting answer length | voting answer text= |
| Selection type;1; 2 | padding |
+-+-+-+-+-+-+-+-+-+-+-+-+-+-+-+-+-+-+-+-+-+-+-+-+-+-+-+-+-+-+-+-+

In detail, the meanings of the fields in the RTCP message illustrated in Table 2 are as follows:
V=2:
RTP version number;
P:
Indicator for padding;
10101:
Sub-type of message 10101 means “Voting_Answer”; the indicated value is only an exemplary value, and may also be chosen differently;
PT=APP=204:
Indicator for application-defined RTCP message;
Length:
Length of the message after the length field in words (32 bits);
SSRC:
Synchronization source of the responding PoC subscriber; the SSRC uniquely identifies the sender of media streams and is defined in the RTP packets associated with the RTCP message;
Name=PoC1:
Application-defined message name (PoC1=PTT over Cellular Version 1);
SDES CNAME item followed by SDES NAME item:
CNAME and NAME of the subscriber terminal which is responding;
CNAME and NAME are so-called SDES items which are defined in SDES RTCP packets in order to describe an RTP subscriber;
CNAME is a unique subscriber name, which also still exists outside specific RTP sessions (for example comprising a user name and host IP address);
NAME is any desired name of the subscriber, which is typically specified by the subscriber himself;
NAME need not uniquely identify the subscriber; as in the case of SDES RTCP packets, the list of SDES items CNAME and NAME is uniquely terminated by an SDES item of the 00000000 type; the list is then padded with zeros up to multiples of 32 bits;
Voting answer length:
Length of the “voting answer text” field in bytes. The “voting answer length” field comprises 16 bits;
Voting answer text:
Text for specification of the voting response;
Padding:
Zeros for filling the “voting question length and text” field to integer multiples of 32 bits.

According to this exemplary embodiment of the invention, it is additionally assumed without any restriction to generality that, after a short time, the second subscriber changes his opinion with regard to the response selection and in that he changes his response to the third possible response, and selects the response “Brocken”. The optional capability to correct a response, in other words renewed selection of a different voting response and the corresponding transmission of this information to the conference server unit 101, is possible until the possible response time has elapsed.

The information which identifies the voting question or the voting response may be a cross-reference to a voting response or voting question stored in another server unit, in which case, by way of example, unambiguous addressing is provided for the question or response, for example using a Unique Resource Identifier (URI), or alternatively the voting question or the voting response may itself be included in the respective voting message or in the voting response message. It is alternatively possible to use only a unique identifier in the voting response message, which is already known in the conference server unit on the basis of a predetermined allocation, to identify the respective voting response which has been selected by the subscriber.

After selection of the new response by the second subscriber T2, the second mobile radio communication terminal 102 produces a second voting response message 206 and likewise transmits this to the conference server unit 101.

The “Voting Answer Text” field of the first voting response message 205 has the following contents, for example:

Selection type; 1;2

The contents mean:
Type of responses=selection type (that is to say that a selection has been made from a plurality of response options);
Total number of selected responses=1;
Number of the selected responses=2 (the number refers to the sequence of possible responses stated in the voting question, that is to say in the voting message (that is to say the voting responses in the respective voting message 201, 202, 203, 204), with the voting response “Mount Everest” having been selected according to this exemplary embodiment of the invention).

Furthermore, this exemplary embodiment is based on the assumption that the third subscriber T3 first of all selects the first possible voting response (that is to say the voting response “Mont Blanc”). In response to the selection made by the third subscriber T3, the third mobile radio communication terminal 104 produces a third voting response message 207 in accordance with the RTCP, and transmits this RTCP data packet to the conference server unit 101. According to this exemplary embodiment, the third subscriber T3 is likewise uncertain, and cancels his response, that is to say his previously chosen selection, by initiating a response cancellation message which is produced by the third mobile radio communication terminal 104 as a voting response cancellation message 208, which is transmitted to the conference server unit 101. The voting response cancellation message 208 is likewise coded in accordance with the RTCP, and is transmitted to the conference server unit 101.

Table 3, below, illustrates one possible example of the layout of the format of the voting response cancellation message 208.

TABLE 3
format of the RTCP message for cancellation of a voting response

0 1 2 3
0 1 2 3 4 5 6 7 8 9 0 1 2 3 4 5 6 7 8 9 0 1 2 3 4 5 6 7 8 9 0 1
+-+-+-+-+-+-+-+-+-+-+-+-+-+-+-+-+-+-+-+-+-+-+-+-+-+-+-+-+-+-+-+-+
|V=2|P|1 0 1 1 0| PT=APP=204 | length |
+-+-+-+-+-+-+-+-+-+-+-+-+-+-+-+-+-+-+-+-+-+-+-+-+-+-+-+-+-+-+-+-+
| SSRC of responding participant |
+-+-+-+-+-+-+-+-+-+-+-+-+-+-+-+-+-+-+-+-+-+-+-+-+-+-+-+-+-+-+-+-+
| name=PoC1 |
+-+-+-+-+-+-+-+-+-+-+-+-+-+-+-+-+-+-+-+-+-+-+-+-+-+-+-+-+-+-+-+-+
| SDES CNAME item followed by SDES NAME item |
+-+-+-+-+-+-+-+-+-+-+-+-+-+-+-+-+-+-+-+-+-+-+-+-+-+-+-+-+-+-+-+-+

In detail, the meanings of the fields in the RTCP message illustrated in Table 3 are as follows:
V=2:
RTP version number;
P:
Indicator for padding;
10110:
Sub-type of message 10110 means
“Voting_Answer_Delete”; the indicated value is only an exemplary embodiment and may also be selected differently;
PT=APP=204:
Indicator for application-defined RTCP message;
Length:
Length of the message after the length field in words (32 bits);
SSRC:
Synchronization source of the PoC subscriber who is canceling his response; the SSRC uniquely identifies the sender of media streams and is defined in the RTP packets associated with the RTCP message;
Name=PoC1:
Application-defined message name (PoC1=PTT over Cellular Version 1);
SDES CNAME item followed by SDES NAME item:
CNAME and NAME of the subscriber terminal which is canceling its response;
CNAME and NAME are so-called SDES items which are defined in SDES RTCP packets in order to describe an RTP subscriber;
CNAME is a unique subscriber name, which also still exists outside specific RTP sessions (for example comprising a user name and host IP address);
NAME is any desired name of the subscriber, which is typically specified by the subscriber himself;
NAME need not uniquely identify the subscriber; as in the case of SDES RTCP packets, the list of SDES items CNAME and NAME is uniquely terminated by an SDES item of the 00000000 type; the list is then padded with zeros up to multiples of 32 bits.

The exemplary embodiment is also based on the assumption that the third subscriber T3 does not send any further voting response messages.

It is also assumed that the fourth subscriber T4 is uncertain, and does not select his response until after the response period that has been provided, and only then initiates a corresponding, fourth voting response message 209, which is produced at this stage by the fourth mobile radio communication terminal 105 and is transmitted to the conference server unit 101. The response, that is to say the voting response messages 205, 206, 207, 208, 209, are collected by the conference server unit 101 within the response time that is provided. Once all of the response messages have arrived at the conference server unit 101, or when the response time period has elapsed, the conference server unit 101 combines the responses which have arrived within the response period to form a voting message, which is also referred to in the following text as the voting combination message 210, and codes this and transmits it in accordance with the RTCP to the mobile radio communication terminal initiating the voting, that is to say to the first mobile radio communication terminal 102 according to this embodiment of the invention.

By way of example, Table 4, below, shows one example of the format of the voting combination message 210.

TABLE 4
format for the RTCP message for combination of a plurality of
voting responses

0 1 2 3
0 1 2 3 4 5 6 7 8 9 0 1 2 3 4 5 6 7 8 9 0 1 2 3 4 5 6 7 8 9 0 1
+-+-+-+-+-+-+-+-+-+-+-+-+-+-+-+-+-+-+-+-+-+-+-+-+-+-+-+-+-+-+-+-+
|V=2|P| 1 0 1 0 1| PT=APP=204 | length |
+-+-+-+-+-+-+-+-+-+-+-+-+-+-+-+-+-+-+-+-+-+-+-+-+-+-+-+-+-+-+-+-+
| SSRC of PTT server |
+-+-+-+-+-+-+-+-+-+-+-+-+-+-+-+-+-+-+-+-+-+-+-+-+-+-+-+-+-+-+-+-+
| name=PoC1 |
+-+-+-+-+-+-+-+-+-+-+-+-+-+-+-+-+-+-+-+-+-+-+-+-+-+-+-+-+-+-+-+-+
| SDES CNAME item followed by SDES NAME item |
+-+-+-+-+-+-+-+-+-+-+-+-+-+-+-+-+-+-+-+-+-+-+-+-+-+-+-+-+-+-+-+-+
| voting answer length | voting answer text= |
| Selection type; | 1; 2 padding |
+-+-+-+-+-+-+-+-+-+-+-+-+-+-+-+-+-+-+-+-+-+-+-+-+-+-+-+-+-+-+-+-+
: :
+-+-+-+-+-+-+-+-+-+-+-+-+-+-+-+-+-+-+-+-+-+-+-+-+-+-+-+-+-+-+-+-+
| SDES CNAME item followed by SDES NAME item |
+-+-+-+-+-+-+-+-+-+-+-+-+-+-+-+-+-+-+-+-+-+-+-+-+-+-+-+-+-+-+-+-+
| voting answer length | voting answer text= |
| Selection type;1; 2 | padding |
+-+-+-+-+-+-+-+-+-+-+-+-+-+-+-+-+-+-+-+-+-+-+-+-+-+-+-+-+-+-+-+-+

In detail, the meanings of the fields of the RTCP message illustrated in Table 4 are as follows:
V=2:
RTP version number;
P:
Indicator for padding;
10101:
Sub-type of message, 10101 means “Voting_Answer”; the indicated value is only an exemplary value, and may also be selected differently;
PT=APP=204:
Indicator for application-defined RTCP message;
Length:
Length of the message after the length field in words (32 bits);
SSRC:
Synchronization source of the PTT server which sends the combination message; the SSRC uniquely identifies the sender of media streams and is defined in the RTP packets associated with the RTCP message;
Name=PoC1:
Application-defined message name (PoC1=PTT over Cellular Version 1);
SDES CNAME item followed by SDES NAME item:
CNAME and NAME of the subscriber terminal which is responding;
CNAME and NAME are so-called SDES items which are defined in SDES RTCP packets in order to describe an RTP subscriber;
CNAME is a unique subscriber name, which also still exists outside specific RTP sessions (for example comprising a user name and host IP address);
NAME is any desired name of the subscriber, which is typically specified by the subscriber himself;
NAME need not uniquely identify the subscriber; as in the case of SDES RTCP packets, the list of SDES items CNAME and NAME is uniquely terminated by an SDES item of the 00000000 type; the list is then padded with zeros up to multiples of 32 bits;
Voting answer length:
Length of the “voting answer text” field in bytes; the “voting answer length” field comprises 16 bits;
Voting answer text:
Text for specification of the voting response;
Padding:
Zeros to fill the “voting answer length and text” field to an integer multiple of 32 bits.

An “SDES item”, a “voting answer length”, a “voting answer text” and, if appropriate, a padding field are transmitted in each subscriber response.

Voting response messages which arrive at the conference server unit 101 outside the response time period that is provided, such as the fourth voting response message 209 from the fourth mobile radio communication terminal 105, are ignored in the voting combination message 210.

The conference server unit 101 sends the voting combination message 210 in accordance with the RTCP to the first mobile radio communication terminal 102 and thus to the first subscriber T1, since he initiated the voting. The first mobile radio communication terminal 102 decodes the received voting combination message and uses it to determine the combination of the responses, and thus automatically evaluates the received responses and sends the result, for example using Short Message Service (SMS), as corresponding SMS messages to the subscribers T2, T3, T4 involved in the voting (not illustrated in FIG. 2).

In this context, it should be noted that voting messages can also use different types of responses than the “selection type” indicated in the above example. Possible response types which may be provided include:
Set of text (“selection type”)
Integer number from . . . to . . . ,
Real number from . . . to . . . ,
Any desired text,
. . .

A voting message in general has the preferred format illustrated in Table 1, above. In the example there, the “voting question text” field contains the details of the question in text form. The general syntax of the “voting question text” field is described in the following text in accordance with the so-called Backus Naur Form (BNF).

Elements are defined by means of the “=”;

“[“,”]” mean optional elements;

“*” defines repetitions;

“/” separates alternative elements.

Voting question = question text “;” responses [“;” response time]
Question text = Text
Text = *ALPHANUM
Responses = response type “;” number of responses [“;” parameter]
Response type = “selection type” / “integer type” / “real number type” /
“text type”
Number of responses =positive integer
Parameter = (Text *(“;“ Text)) / limit
Limit = (integer integer) / (real number real number)
Response time = start time “;” end time
Start time = positive integer
End time = positive integer
Positive integer =1*NUM
Integer = [“+” / “−”] 1*NUM
Real number = [“+” / “−”] 1*NUM [“.” 1*NUM]

In this case “ALPHANUM” means an alphanumeric symbol and NUM a number.

In one alternative embodiment of the invention, the response time is not stated. In this case, an unlimited time period from the current time or the time of the push-to-talk communication session is assumed as the response time period, that is to say the time for which the conference continues. This is worthwhile in particular in the situation when the evaluation requires responses from all subscribers or when the evaluation time is not yet fixed with respect to the question time.

If an inconsistent time period is stated as the response time period, that is to say for example if the start time occurs at a time after the end time (start time≧end time), then an unlimited time period from the current time, or the time of the push-to-talk communication session, is likewise assumed as the response time period.

Different response types can also be used in one voting response message, corresponding to the possible response types in a voting question message.

Table 2 above shows the general format of a voting response message according to these exemplary embodiments of the invention. The general syntax of the “voting answer” field is given by the following Backus Naur Form:

Response=response type “;” number of responses “;” values

Response type=“selection type”/“integer type”/“real number type”/“TextTyp”

Number of responses=positive integer

Values=value*(“;”value)

Value=positive integer/integer/real number/text

Positive integer=1*NUM

The conference server unit (PTT server unit) 101 combines a plurality of subscriber responses in the voting combination message as shown in Table 4. The voting combination message 210 is sent to the voting manager, that is to say to the subscriber who produced the question. The responses from the subscribers are listed in the voting combination message 210 in the sequence of their arrival at the conference server unit 101. This also makes it possible to take account of the sequence of the responses in the response evaluation. This is important, for example, for the implementation of reaction games. In one alternative embodiment of the invention, it is possible to provide for the respective response to be associated with time detail and to be transmitted together with the voting combination message, with this indicating when the respective voting response message arrived at the conference server unit 101, or the time at which the voting response message was sent by the respective mobile radio communication terminal.

Questions can also be cancelled again by the voting manager. In order to do this, the mobile radio communication terminal of the voting manager produces the message as shown in Table 5 below, and sends this to the conference server unit 101. The conference server unit 101 then distributes this message to the subscribers, to be precise to their mobile radio communication terminals. Cancellation of the voting ends the voting process.

Table 5 below shows the format of the voting cancellation message according to one exemplary embodiment of the invention:

TABLE 5
format of the RTCP message for cancellation of a voting question

0 1 2 3
0 1 2 3 4 5 6 7 8 9 0 1 2 3 4 5 6 7 8 9 0 1 2 3 4 5 6 7 8 9 0 1
+-+-+-+-+-+-+-+-+-+-+-+-+-+-+-+-+-+-+-+-+-+-+-+-+-+-+-+-+-+-+-+-+
|V=2|P| 1 0 1 1 1| PT=APP=204 | length |
+-+-+-+-+-+-+-+-+-+-+-+-+-+-+-+-+-+-+-+-+-+-+-+-+-+-+-+-+-+-+-+-+
| SSRC of voting initiator |
+-+-+-+-+-+-+-+-+-+-+-+-+-+-+-+-+-+-+-+-+-+-+-+-+-+-+-+-+-+-+-+-+
| name=PoC1 |
+-+-+-+-+-+-+-+-+-+-+-+-+-+-+-+-+-+-+-+-+-+-+-+-+-+-+-+-+-+-+-+-+
| SDES CNAME item followed by SDES NAME item |
+-+-+-+-+-+-+-+-+-+-+-+-+-+-+-+-+-+-+-+-+-+-+-+-+-+-+-+-+-+-+-+-+

In detail, the meanings of the fields of the RTCP message illustrated in Table 5 are as follows:
V=2:
RTP version number;
P:
Indicator for padding;
10111:
Sub-type of message, 10111 means “Voting_Question_Delete”; the stated value is only an exemplary value and can also be selected differently;
PT=APP=204:
Indicator for application-defined RTCP message;
Length:
Length of the message after the length field in words (32 bits);
SSRC:
Synchronization source of the PoC subscriber who is canceling his question; the SSRC uniquely identifies the sender of media streams and is defined in the RTP packets associated with the RTCP message;

Name=PoC1:
Application-defined message name (PoC1=PTT over Cellular Version 1);
SDES CNAME item followed by SDES NAME item:
CNAME and NAME of the subscriber terminal which is canceling its question;
CNAME and NAME are so-called SDES items which are defined in SDES RTCP packets in order to describe an RTP subscriber;
CNAME is a unique subscriber name, which also still exists outside specific RTP sessions (for example comprising a user name and host IP address);
NAME need not uniquely identify the subscriber; as in the case of SDES RTCP packets, the list of SDES items CNAME and NAME is uniquely terminated by an SDES item of the 00000000 type; the list is then padded with zeros up to multiples of 32 bits.

By way of example, it may be worthwhile canceling a voting when a sufficiently large number of responses from subscribers have already been passed to the voting, even though the response time period has not yet elapsed and the subscribers have not yet all responded. The voting manager can use the message as defined and described in detail further below for checking of intermediate results to determine how many responses have already been received, that is to say how many voting response messages have already been received.

A question may also be cancelled for other reasons, for example because the question no longer appears to be worthwhile or of interest.

A response which has already been sent can be cancelled again by the subscriber who sent the response, in two different ways. Firstly, the subscriber, that is to say his mobile radio communication terminal, can send a voting response message once again. This renders the old response inoperative. Only the most recently sent voting response message is ever valid. Secondly, the subscriber, that is to say his mobile radio communication terminal, can send the message shown in Table 3 to the conference server unit 101. In this way, the subscriber, that is to say his mobile radio communication terminal, cancels his response without having to replace it by another. The response status of the subscriber corresponds to the response status of a subscriber who has not produced any response.

The voting manager, that is to say his mobile radio communication terminal, need not wait until all of the new subscribers have responded and the response phase for the voting has elapsed in order to obtain a voting result. The voting manager can in fact question an intermediate result relating to the voting even during the voting response phase, by sending the message shown in Table 6 in accordance with the RTCP to the conference server unit 101.

Table 6, below, shows the format of an intermediate result question message in accordance with the RTCP, according to one exemplary embodiment of the invention:

TABLE 6
format of the RTCP message for cancellation of a voting question

0 1 2 3
0 1 2 3 4 5 6 7 8 9 0 1 2 3 4 5 6 7 8 9 0 1 2 3 4 5 6 7 8 9 0 1
+-+-+-+-+-+-+-+-+-+-+-+-+-+-+-+-+-+-+-+-+-+-+-+-+-+-+-+-+-+-+-+-+
|V=2|P| 1 1 0 0 0| PT=APP=204 | length |
+-+-+-+-+-+-+-+-+-+-+-+-+-+-+-+-+-+-+-+-+-+-+-+-+-+-+-+-+-+-+-+-+
| SSRC of rquesting participant |
+-+-+-+-+-+-+-+-+-+-+-+-+-+-+-+-+-+-+-+-+-+-+-+-+-+-+-+-+-+-+-+-+
| name=PoC1 |
+-+-+-+-+-+-+-+-+-+-+-+-+-+-+-+-+-+-+-+-+-+-+-+-+-+-+-+-+-+-+-+-+
| SDES CNAME item followed by SDES NAME item |
+-+-+-+-+-+-+-+-+-+-+-+-+-+-+-+-+-+-+-+-+-+-+-+-+-+-+-+-+-+-+-+-+

In detail, the meanings of the fields in the RTCP message illustrated in Table 6 are as follows:
V=2:
RTP version number;
P:
Indicator for padding;
11000:
Sub-type of message 11000 means “Voting_Answers_Question”; the indicated value is only an exemplary value and can also be selected differently;
PT=APP=204:
Indicator for application-defined RTCP message;
Length:
Length of the message after the length field in words (32 bits);
SSRC:
Synchronization source of the PoC subscriber who is requesting the responses given up till now; the SSRC uniquely identifies the sender of media streams and is defined in the RTP packets associated with the RTCP message;
Name=PoC1:
Application-defined message name (PoC1=PTT over Cellular Version 1);
SDES CNAME item followed by SDES NAME item:
CNAME and NAME of the subscriber terminal which is requesting the responses given up till now; CNAME and NAME are so-called SDES items which are defined in SDES RTCP packets in order to describe an RTP subscriber;
CNAME is a unique subscriber name, which also still exists outside specific RTP sessions (for example comprising a user name and host IP address);
NAME is any desired name of the subscriber, which is typically specified by the subscriber himself;
NAME need not uniquely identify the subscriber; as in the case of SDES RTCP packets, the list of SDES items CNAME and NAME is uniquely terminated by an SDES item of the 00000000 type; the list is then padded with zeros up to multiples of 32 bits.

On receiving the intermediate result question message, the conference server unit 101 first of all checks whether the questioning subscriber is authorized to question results or intermediate results of the voting. If the subscriber, that is to say his mobile radio communication terminal, is authorized to do so because, for example as assumed in this case, he is the initiator of the voting, the conference server unit 101 responds with a voting combination message, as illustrated above in Table 4, which contains all of the responses emitted up to the time of the checking message.

The representation of the possible responses to voting is left to the communication terminal. In particular, the selection type responses in the above example can also be made selectable by means other than radio buttons, for example by means of a pop-up menu or by means of freely selectable text information inputs.

According to another embodiment of the invention, the responses to voting are evaluated in another communication terminal and not in a subscriber communication terminal. Alternatively, they can also be evaluated in a network element. For this purpose, the network element is used as a subscriber to the push-to-talk communication session, and initiates the voting and the sending of the voting question to the subscribers involved in the push-to-talk communication session.

Instead of evaluation of the voting as in the above example by means of the voting manager, that is to say his mobile radio communication terminal, with the result being distributed to the subscribers by means of SMS, the voting manager can pass the voting combination message relating to the voting directly to the subscribers.

Alternatively, the voting question can also be presented to a subscriber as an audio data stream. This can be carried out in the following different ways:
1. Firstly, a question which is received in text form can be converted to audio data by the subscriber communication terminal, and can be emitted from it.
2. Secondly, an audio data stream can be transmitted instead of a text voting question in the voting message, whose content represents the voting question. In this case, the format of the voting message must be extended appropriately so that other data formats, for example other media data streams, can also be transmitted. The voting question can also be presented by other media forms, for example as an image or as a film.
3. The voting question can also be sent by means of a push-to-talk talk burst. In this case, the voting question message as described in the example is sent, with the voting question message additionally including information that the voting question is (only or additionally) being sent in the form of the current talk burst.

Alternatively, it is possible to provide not only for the previously given responses to be combined in the voting combination message of the push-to-talk conference server unit but, in addition, also to state which communication session subscribers have not yet responded so far. The format shown in Table 4 above for a voting combination message can likewise be used to transmit this information. Entries are likewise made for those subscribers who have not yet responded, to be precise with the values: “Voting Answer Length” field=0 and “Voting Answer Text” field=empty.

The manager of a voting process will often not himself take part in the voting or respond to it. In principle, however, the voting manger can also take part in his own voting process. In this case, the voting application of the subscriber communication terminal of the voting manager should not make any information relating to previous voting responses available to the voting manager during the response time period.

Instead of having to specify the time duration of a voting process in the voting question message by means of absolute times, the time duration can also be specified relative to the current time. Alternatively, events can also be stated as time constraints for the voting, and, for example, it is possible to define the end of the voting process by the emission of responses from at least n subscribers. It is also possible to use a format other than the NTP time stamp for time details.

The conference server unit 101 can also transmit the times of the individual subscriber responses in the voting combination message. The format of the voting combination message can be extended for this purpose as shown in Table 7, below:

TABLE 7
format of the RTCP message for response to a voting question, with time
details

0 1 2 3
0 1 2 3 4 5 6 7 8 9 0 1 2 3 4 5 6 7 8 9 0 1 2 3 4 5 6 7 8 9 0 1
+-+-+-+-+-+-+-+-+-+-+-+-+-+-+-+-+-+-+-+-+-+-+-+-+-+-+-+-+-+-+-+-+
|V=2|P| 1 1 0 0 1| PT=APP=204 | length |
+-+-+-+-+-+-+-+-+-+-+-+-+-+-+-+-+-+-+-+-+-+-+-+-+-+-+-+-+-+-+-+-+
| SSRC of responding participant |
+-+-+-+-+-+-+-+-+-+-+-+-+-+-+-+-+-+-+-+-+-+-+-+-+-+-+-+-+-+-+-+-+
| name=PoC1 |
+-+-+-+-+-+-+-+-+-+-+-+-+-+-+-+-+-+-+-+-+-+-+-+-+-+-+-+-+-+-+-+-+
|SDES CNAME item followed by SDES NAME item |
+-+-+-+-+-+-+-+-+-+-+-+-+-+-+-+-+-+-+-+-+-+-+-+-+-+-+-+-+-+-+-+-+
| voting answer time |
+-+-+-+-+-+-+-+-+-+-+-+-+-+-+-+-+-+-+-+-+-+-+-+-+-+-+-+-+-+-+-+-+
| voting answer length | voting answer text= |
| Selection type;1; 2 | padding |
+-+-+-+-+-+-+-+-+-+-+-+-+-+-+-+-+-+-+-+-+-+-+-+-+-+-+-+-+-+-+-+-+

In detail, the meanings of the fields in the RTCP message illustrated in Table 7 are as follows:
V=2
RTP version number;
P:
Indicator for padding;
11001:
Sub-type of message, 11001 means “Voting_Answer” with time details; the stated value is only an exemplary value, and can also be chosen differently;
PT=APP=204:
Indicator for application-defined RTCP message;
Length:
Length of the message after the length field in words (32 bits);
SSRC:
Synchronization source of the responding PoC subscriber. The SSRC uniquely identifies the sender of media streams and is defined in the RTP packets associated with the RTCP message;
Name=PoC1:
Application-defined message name (PoC1=PTT over Cellular Version 1);
SDES CNAME item followed by SDES NAME item:
CNAME and NAME of the subscriber terminal which is responding;
CNAME and NAME are so-called SDES items which are defined in SDES RTCP packets in order to describe an RTP subscriber;
CNAME is a unique subscriber name, which also still exists outside specific RTP sessions (for example comprising a user name and host IP address);
NAME is any desired name of the subscriber, which is typically specified by the subscriber himself;
NAME need not uniquely identify the subscriber; as in the case of SDES RTCP packets, the list of SDES items CNAME and NAME is uniquely terminated by an SDES item of the 00000000 type; the list is then padded with zeros up to multiples of 32 bits;
Voting answer time:
Time of response in the NTP time stamp format;
Voting answer length:
Length of the “voting answer text” field in bytes; the “voting answer length” field comprises 16 bits;
Voting answer text:
Text to specify the voting response;
Padding:
Zeros to fill the “voting answer length and text” field to an integer multiple of 32 bits.

The details of the response times allow more accurate evaluation of the reaction times of the subscribers, for example for games.

A plurality of voting processes can also be carried out at the same time within a push-to-talk communication session. In order to make it possible to distinguish between the RTCP messages from different voting processes, they are provided with additional fields, which identify the voting processes.

Table 8, below, shows a corresponding extension of the format of the voting messages:

TABLE 8
addition of a voting identifier to the voting messages

0 1 2 3
0 1 2 3 4 5 6 7 8 9 0 1 2 3 4 5 6 7 8 9 0 1 2 3 4 5 6 7 8 9 0 1
+-+-+-+-+-+-+-+-+-+-+-+-+-+-+-+-+-+-+-+-+-+-+-+-+-+-+-+-+-+-+-+-+
|V=2|P|X X X X X| PT=APP=204 | length |
+-+-+-+-+-+-+-+-+-+-+-+-+-+-+-+-+-+-+-+-+-+-+-+-+-+-+-+-+-+-+-+-+
| SSRC |
+-+-+-+-+-+-+-+-+-+-+-+-+-+-+-+-+-+-+-+-+-+-+-+-+-+-+-+-+-+-+-+-+
| name=PoC1 |
+-+-+-+-+-+-+-+-+-+-+-+-+-+-+-+-+-+-+-+-+-+-+-+-+-+-+-+-+-+-+-+-+
| SDES CNAME item followed by SDES NAME item |
+-+-+-+-+-+-+-+-+-+-+-+-+-+-+-+-+-+-+-+-+-+-+-+-+-+-+-+-+-+-+-+-+
| SSRC of voting initiator |
+-+-+-+-+-+-+-+-+-+-+-+-+-+-+-+-+-+-+-+-+-+-+-+-+-+-+-+-+-+-+-+-+
| voting ID |
+-+-+-+-+-+-+-+-+-+-+-+-+-+-+-+-+-+-+-+-+-+-+-+-+-+-+-+-+-+-+-+-+
| additional data |
: :
| |
+-+-+-+-+-+-+-+-+-+-+-+-+-+-+-+-+-+-+-+-+-+-+-+-+-+-+-+-+-+-+-+-+

In detail, the meanings of the fields in the RTCP message illustrated in Table 8 are as follows:
V=2:
RTP version number;
P:
Indicator for padding;
XXXXX:
Sub-type of the message, value depending on the voting message;
PT=APP=204:
Indicator for application-defined RTCP message;
Length:
Length of the message after the length field in words (32 bits);
SSRC:
Synchronization source of the sender (subscriber terminal or PTT server); the SSRC uniquely identifies the sender of media streams and is defined in the RTP packets associated with the RTCP message;
Name=PoC1:
Application-defined message name (PoC1=PTT over Cellular Version 1);
SDES CNAME item followed by SDES NAME item:
CNAME and NAME of the sender (subscriber terminal or PTT server); CNAME and NAME are so-called SDES items which are defined in SDES RTCP packets in order to describe an RTP subscriber;
CNAME is a unique subscriber name, which also still exists outside specific RTP sessions (for example comprising a user name and host IP address);
NAME is any desired name of the subscriber, which is typically specified by the subscriber himself;
NAME need not uniquely identify the subscriber; as in the case of SDES RTCP packets, the list of SDES items CNAME and NAME is uniquely terminated by an SDES item of the 00000000 type; the list is then padded with zeros up to multiples of 32 bits;
SSRC of voting initiator:
SSRC of the subscriber who initiated the voting;
Voting ID:
A number for unique identification of the voting among the voting processes of the initiating subscriber;
Additional data:
Further information for the voting message; the information depends on the sub-type of message and corresponds to the additional information which is stated in the voting messages (without a voting identifier) defined above.

The identification of the voting processes comprises the SSRC of the respective voting initiator and an additional voting number. If one subscriber uses the voting number of a voting process that is already taking place for a second time in a voting question, the first of the two voting processes is ended, and the second is initiated.

The response to a selection question can alternatively also be in the form of text. The “Voting Answer Text” field which corresponds to the above example then reads: Texttype;1;Mount Everest.

Further response types than the others stated above can also be defined as possible responses, for example the reception of a speech message.

Media other than text can also be used as possible responses, for example images or speech messages.

The “voting question text” field and the “voting answer text” field in an RTCP voting question message or an RTCP voting response can also be formatted in ways other than those stated in the above examples.

In one alternative embodiment of the invention, use is envisaged not only in a push-to-talk communication system for the transmission of audio data but also use in a push-to-talk communication system for transmission of other data, in particular for transmission of other media data.

Furthermore, alternatively, the communication system, for example the conference system, is not designed as a push-to-talk communication system but as a different conference system which uses the RTCP, in general a real-time transport-protocol control protocol, in particular as a communication system with a conference system in accordance with the IETF.

Furthermore, voting processes by means of RTCP can be used in order to agree which subscriber should be the next to be given the speech right (floor control). For this purpose, a subscriber in the form of a machine takes part in the communication, as the voting manager. This subscriber initiates the voting as to which subscriber should be the next to be assigned to the speech right, and evaluates the given responses. The machine subscriber should be authorized to be able to allocate the speech right, that is to say in other words, this subscriber has the function of the so-called “floor chair”. The machine subscriber allocates the speech right depending on the result of the evaluation.

One aspect of the invention is the sending of voting messages as specific RTCP data packets in a communication system which uses the real-time control protocol (RTCP).

Internet-Protocol-based communication systems (such as push-to-talk communication systems or conference systems based on the Internet protocol (IP)) generally use the real-time transport protocol (RTP) in order to transmit media data. The RTP communication links are monitored with the aid of the RTCP. According to one aspect of the invention, the RTCP communication links are used for the transmission of specific RTCP messages for voting functionalities.

According to another aspect of the invention, specific RTCP messages are defined for the transmission of the voting question, the voting responses and the cancellation of voting questions and voting responses.

One advantage of the definition of the specific voting messages is that the voting can be evaluated by a machine. If the possible responses which can be selected are not defined, then it is possible to provide for the evaluation unit to contain a Parser unit, which automatically analyzes the responses given in the form of plain text, and determines the voting result from this.

The voting messages have a simple format and are text-based, which has the advantage that the messages are easily legible and are short.

The central conference server unit in the communication system combines the voting responses in an RTCP message. The conference server unit informs the voting manager about the voting result by sending a voting combination message. This has the advantage that the conference server unit need send only one message in order to notify the voting manager of the voting result. Since the voting results are collected and stored centrally, voting (intermediate) results can advantageously also be checked by a questioning subscriber communication terminal.

The voting result can be evaluated by a subscriber communication terminal or by an element in the communication network. This has the advantage that the architecture of the voting communication system can be defined to be flexible.

What is claimed is:

1. A method for computer-aided creation of a voting message in a conference between a plurality of communication terminals, comprising coding the voting message in accordance with a transport-protocol control protocol by means of which a transport protocol is controlled, with an information item identifying at least one voting question or an information item identifying at least one voting response being added to the voting message.

2. The method as claimed in claim 1, wherein the voting message includes a time period in which responses to the at least one voting question will be accepted.

3. A method for computer-aided determination of at least one voting result of at least one voting question in a conference between a plurality of communication terminals, comprising:
decoding at least one received voting response message, which is coded in accordance with a transport-protocol control protocol by means of which a transport protocol is controlled, with the voting response message including at least one response to the at least one voting question for voting;
determining the at least one response from the decoded voting response message; and
determining at least one voting result using the at least one response.

4. The method as claimed in claim 3, wherein an intermediate determination of the at least one voting result can be made before all communication terminals have responded or a specified time period has elapsed.

5. The method as claimed in claim 1, further comprising using a real-time transport-protocol control protocol as the transport-protocol control protocol by means of which a real-time transport protocol is controlled.

6. The method as claimed in claim 5, further comprising using the real-time transport control protocol as the real-time transport-protocol control protocol.

7. The method as claimed in claim 5, further comprising using the real-time transport protocol as the real-time transport protocol.

8. The method as claimed in claim 1, further comprising carrying out the at least one voting in a half-duplex conference.

9. The method as claimed in claim 8, further comprising carrying out the at least one voting in a push-to-talk conference.

10. The method as claimed in claim 9, further comprising carrying out the at least one voting in a push-to-talk over cellular conference.

11. The method as claimed in claim 1, further comprising carrying out the at least one voting in an Internet-Protocol-based conference.

12. The method as claimed in claim 3, further comprising:
receiving the at least one voting response message by a conference server unit; or
determining the at least one voting result by a conference server unit.

13. The method as claimed in claim 3, further comprising:
receiving and combining a plurality of voting response messages by a conference server unit, into a voting combination message; and
transmitting the voting combination message to at least one communication terminal which is taking part in the conference.

14. The method as claimed in claim 13, further comprising transmitting the voting combination message to a communication terminal which initiated the voting

15. The method as claimed in claim 3, further comprising transmitting the determined at least one voting result to at least one communication terminal which is taking part in the conference.

16. The method as claimed in claim 15, further comprising transmitting the determined at least one voting result to the communication terminal which initiated the at least one voting.

17. The method as claimed in claim 3, further comprising:
receiving the at least one voting response message by a conference server unit; and
transmitting the voting response message or at least one voting response information item which is contained in the voting response message to at least one communication terminal which is taking part in the conference.

18. The method as claimed in claim 17, further comprising transmitting the determined voting response message or at least one voting response information item which is contained in the voting response message to a communication terminal which initiated the voting.

19. A method for computer-aided processing of a voting message in a conference between a plurality of communication terminals, comprising:
receiving a voting message which is coded in accordance with a transport-protocol control protocol by means of which a transport protocol is controlled;
determining an information item which identifies at least one voting question or an information item which identifies at least one voting response which is contained in the voting message from the voting message;
displaying a user of a communication terminal which is taking part in the voting of the at least one voting question or at least one voting response;
a user inputting at least one response to the at least one voting question; and
coding a voting response message in accordance with a transport-protocol control protocol by means of which a transport protocol is controlled, with an information item which identifies the at least one response to the at least one voting question being added to the voting response message.

20. The method as claimed in claim 19, further comprising using a real-time transport-protocol control protocol by means of which a real-time transport protocol is controlled as the transport-protocol control protocol.

21. The method as claimed in claim 19, further comprising sending the voting response message to a conference server unit.

22. The method as claimed in claim 20, further comprising using the real-time transport control protocol as the real-time transport-protocol control protocol.

23. The method as claimed in claim 20, further comprising using the real-time transport protocol as the real-time transport protocol

24. The method as claimed in claim 19, further comprising carrying out the at least one voting in a half-duplex conference.

25. The method as claimed in claim 24, further comprising carrying out the at least one voting in a push-to-talk conference.

26. The method as claimed in claim 25, further comprising carrying out the at least one voting in a push-to-talk over cellular conference.

27. The method as claimed in claim 19, further comprising carrying out the at least one voting in an Internet-Protocol-based conference.

28. A transport-protocol control protocol unit, creating a voting message in a conference between a plurality of communication terminals, with the voting message being coded in accordance with a transport-protocol control protocol by means of which a transport protocol is controlled, and with an information item identifying at least one voting question or an information item identifying at least one voting response being added to the voting message.

29. The transport-protocol control protocol unit as claimed in claim 28, being a real-time transport-protocol control protocol unit, creating a voting message in a conference between a plurality of communication terminals, with the voting message being coded in accordance with a real-time transport-protocol control protocol by means of which a real-time transport protocol is controlled.

30. The transport-protocol control protocol unit as claimed in claim 29, being designed in accordance with the real-time transport control protocol.

31. A conference voting evaluation unit, comprising:
a transport-protocol control protocol unit, decoding at least one voting response message which is coded in accordance with a transport-protocol control protocol by means of which a transport protocol is controlled;
a determination unit determining at least one information item identifying a response to at least one voting question, from the decoded voting response message; and
a voting evaluation unit, determining a voting result using the at least one information item identifying the response to at least one voting question.

32. The conference voting evaluation unit as claimed in claim 31, wherein the transport-protocol control protocol unit is a real-time transport-protocol control protocol unit.

33. The conference voting evaluation unit as claimed in claim 32, wherein the real-time transport-protocol control protocol unit is designed in accordance with the real-time transport control protocol.

34. A conference server unit having a conference voting evaluation unit as claimed in claim 31.

35. A transport-protocol control protocol unit, creating a voting response message in a conference between a plurality of communication terminals, with the voting response message being coded in accordance with a transport-protocol control protocol by means of which a transport protocol is controlled, with an information item identifying at least one voting response to at least one voting question being added to the voting response message.

36. The transport-protocol control protocol unit as claimed in claim 35, being a real-time transport-protocol control protocol unit, creating a voting response message in a conference between a plurality of communication terminals, with the voting message being coded in accordance with a real-time transport-protocol control protocol by means of which a real-time transport protocol is controlled.

37. The transport-protocol control protocol unit as claimed in claim 35, being designed in accordance with the real-time transport control protocol.

38. A communication terminal, comprising:
a conference unit producing a conference with at least one other communication terminal;
a first transport-protocol control protocol unit decoding at least one voting message which is coded in accordance with a transport-protocol control protocol by means of which a transport protocol is controlled;
a determination unit determining at least one information item identifying a voting question or at least one information item identifying a voting response from the decoded voting message;
a display unit displaying the determined information item or the at least one voting question determined from it or at least one voting response to a user;
an input unit for inputting at least one response to the at least one voting question; and
a second transport-protocol control protocol unit creating a voting response message in a conference between a plurality of communication terminals, with the voting response message being coded in accordance with a transport-protocol control protocol by means of which a transport protocol is controlled, and with an information item identifying the at least one response to the at least one voting question being added to the voting response message.
